(19) United States
(12) Patent Application Publication
(10) Pub. No.: US 2020/0202299 A1
(43) Pub. Date: Jun. 25, 2020

(54) DELIVERY-BASED OPTIMIZATIONS FOR JOBS

(71) Applicant: Microsoft Technology Licensing, LLC, Redmond, WA (US)

(72) Inventors: Keqing Liang, Sunnyvale, CA (US); Yin Zhang, Sunnyvale, CA (US)

(73) Assignee: Microsoft Technology Licensing, LLC, Redmond, WA (US)

(21) Appl. No.: 16/230,924

(22) Filed: Dec. 21, 2018

(51) Int. Cl. G06Q 10/08; G06Q 10/04

(52) U.S. Cl. CPC G06Q 10/08345; G06Q 10/04; G06Q 10/0838

(57) ABSTRACT

The disclosed embodiments provide a system for performing delivery-based optimizations for jobs. During operation, the system obtains historical data comprising delivery rates related to overdelivery and underdelivery of jobs with respect to fixed budgets for the jobs. Next, the system applies an optimization technique to the historical data to determine a change to an initial price for a job that improves a utilization of a fixed budget for the job. The system then applies the change to the initial price to produce an updated price for the job and delivers the job within an online system based on the updated price.

### BACKGROUND

### Field

The disclosed embodiments relate to delivery of jobs in online systems. More specifically, the disclosed embodiments relate to techniques for performing delivery-based optimizations for jobs.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for performing delivery-based bid optimizations for jobs in accordance with the disclosed embodiments.

FIG. 3 shows an example plot in accordance with the disclosed embodiments.

FIG. 4 shows a flowchart illustrating a process of performing delivery-based bid optimizations for jobs in accordance with the disclosed embodiments.

FIG. 5 shows a flowchart illustrating a process of calculating an updated price for a job in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing delivery-based bid optimizations for jobs. The jobs are posted within an online system such as an online professional network and/or online marketplace. Each job is associated with a daily budget and/or other type of time-based budget that is spent as users view, click on, apply to, and/or perform other actions related to the job. As a result, the delivery-based bid optimizations may be used to select and/or adjust a price for each job so that the job's budget can be consumed over the course of the day instead of running out too early and/or failing to be used up by the end of the day.

More specifically, the disclosed embodiments use historical data containing delivery rates for jobs and an optimization technique to select prices for the jobs that improve utilization of the corresponding fixed budgets. In some embodiments, the historical data includes delivery rates representing overdelivery of the jobs beyond buffers associated with the fixed budgets, delivery of the jobs between the fixed budgets and the buffers, and/or underdelivery of the jobs below the fixed budgets. Historical relationships among the delivery rates are used to determine optimization objectives associated with the optimization technique, and changes to the jobs' prices may be selected to meet the optimization objectives.

For example, the optimization objectives may include minimizing overdelivery and underdelivery of the jobs as a function of one or more delivery rates of the jobs. The optimization technique may select a target value of a job's delivery rate that minimizes one optimization objective, subject to a constraint associated with another optimization objective. The target value may then be used to calculate a corresponding adjustment to the job's price, and subsequent delivery of the job within the online system may be performed based on the adjusted price.

By using multi-objective optimization to adjust bid prices of jobs, the disclosed embodiments may improve utilization of the jobs' budgets and/or management of other constraints or priorities associated with the jobs. In contrast, conventional techniques may generate bid prices for the jobs based on static rate cards, which have fixed prices for jobs. Such static, fixed pricing of jobs can result in overdelivery of the jobs beyond the jobs' budgets and/or underdelivery of the jobs below the jobs' budgets as interactions with the jobs change and/or fluctuate over time. Consequently, the disclosed embodiments may provide improvements in computer systems, applications, user experiences, tools, and/or technologies related to delivering online content and/or carrying out activities within online systems.

### Delivery-Based Bid Optimizations for Jobs

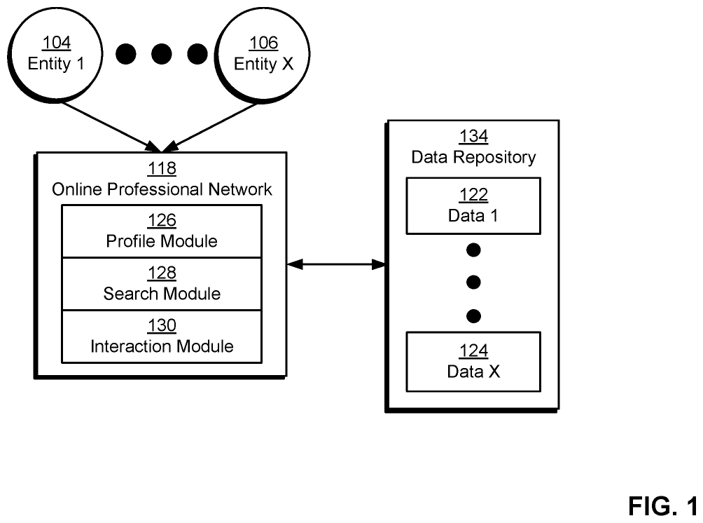

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that delivers, to the entities, the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 may then be used to generate recommendations and/or other insights related to listings of jobs or opportunities within online network 118. For example, one or more components of online network 118 may track searches, clicks, views, text input, applications, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

In one or more embodiments, data repository 134 stores data that represents standardized, organized, and/or classified attributes for the users or entities. For example, skills in data repository 134 may be organized into a hierarchical taxonomy. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve other data that is represented by the time periods (e.g., starting a job in a given month or year, graduating from university within a five-year span, job listings posted within a two-week period, etc.).

More specifically, data in data repository 134 and one or more machine learning models are used to produce rankings related to candidates for jobs or opportunities listed within or outside online network 118. The candidates may include users who have viewed, searched for, or applied to jobs, positions, roles, and/or opportunities, within or outside online network 118. The candidates may also, or instead, include users and/or members of online network 118 with skills, work experience, and/or other attributes or qualifications that match the corresponding jobs, positions, roles, and/or opportunities.

After the candidates are identified, profile and/or activity data of the candidates may be inputted into the machine learning model(s), along with features and/or characteristics of the corresponding opportunities (e.g., required or desired skills, education, experience, industry, title, etc.). The machine learning model(s) may output scores representing the strengths of the candidates with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, etc.).

In turn, rankings based on the scores and/or associated insights may improve the quality of the candidates and/or recommendations of opportunities to the candidates, increase user activity with online network 118, and/or guide the decisions of the candidates and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may recommend highly ranked candidates for a position to recruiters and/or other moderators as potential applicants and/or interview candidates for the position. In a fourth example, the component(s) may recommend jobs to a candidate based on the predicted relevance or attractiveness of the jobs to the candidate and/or the candidate's likelihood of applying to the jobs.

Jobs, advertisements, and/or other types of content displayed or delivered within online network 118 may also be associated with time-based limitations or constraints. For example, posters of jobs may pay per view, click, application, and/or other action taken with respect to the jobs by members of online network 118. The posters may set daily budgets for the jobs, from which costs are deducted as the members take the corresponding actions with the jobs. If a job's budget is fully consumed before the end of the day, the job may continue to be delivered to members (e.g., in search results and/or recommendations) until the end of the day without further charging the job's poster. Moreover, jobs with depleted budgets may occupy space in rankings that are shown to the members, which may prevent online network 118 from surfacing other jobs to the members and/or utilizing the budgets for the other jobs.

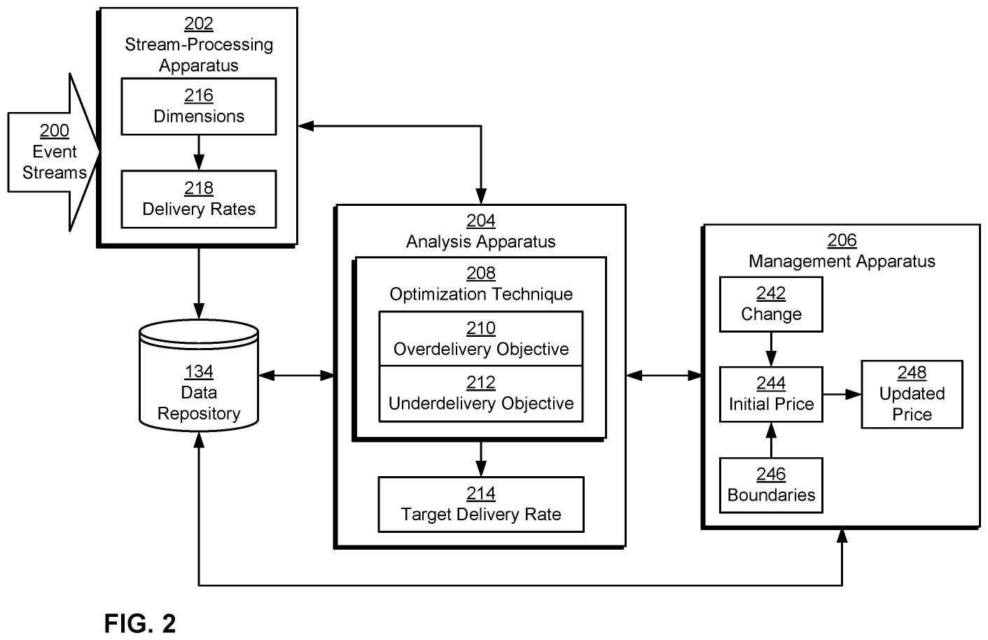

In one or more embodiments, online network 118 manages daily budgets and/or other time-based constraints associated with jobs and/or other content in online network 118 by performing delivery-based bid optimizations based on the daily budgets and/or constraints. For example, online network 118 may select a cost per click (CPC) for each job based on historical delivery rates of the job and/or similar jobs with respect to the jobs' budgets. As described in further detail below with respect to FIG. 2, online network 118 may use multi-objective optimization to set bid prices for jobs that improve utilization of the jobs' daily and/or other fixed budgets, based on historical data and/or parameters associated with rates at which the jobs are “overdelivered” or “underdelivered” with respect to the jobs' budgets. As a result, the bid prices may better reflect the “value” of the jobs within online network 118 and/or allow for a more even exposure of members to the jobs.

FIG. 2 shows a system for performing delivery-based bid optimizations for jobs in accordance with the disclosed embodiments. The system includes a stream-processing apparatus 202, an analysis apparatus 204, and a management apparatus 206. Each of these components is described in further detail below.

Stream-processing apparatus 202 processes event streams 200 containing records of page views, clicks, and/or other activity collected from an online system (e.g., online network 118 of FIG. 1); performance metrics associated with the activity, such as page load times; and/or other time-series data from the online system. In one or more embodiments, event streams 200 are generated and/or maintained using a distributed streaming platform such as Apache Kafka (Kafka™ is a registered trademark of the Apache Software Foundation). When a profile update, job search, job view, job click, job application, response to a job application, connection invitation, post, like, comment, share, purchase, conversion, member registration, and/or other recent activity occurs within or outside the online system, a publisher in the distributed streaming platform generates a record of the activity. The distributed streaming platform may then propagate the record to components subscribing to event streams 200, such as stream-processing apparatus 202.

As shown in FIG. 2, stream-processing apparatus 202 aggregates records of events from event streams 200 along one or more dimensions 216. In some embodiments, groupings of dimensions 216 by which events in event streams 200 are aggregated represent different “job segments” of jobs posted within the online system. For example, dimensions 216 may include job attributes, such as locations or regions of the jobs (e.g., states within the United States); a standardized language, industry, seniority, education, experience level, skills, and/or title associated with each job; a source of applications for the job (e.g., a jobs module or other onsite source within the online system or a company website or another offsite source that is external to the online system); a payment model for the job (e.g., pay per click (PPC) or a prepaid fixed price throughout the job's lifetime); and/or an availability of a standardized company name for an employer associated with the job. In turn, jobs in each job segment may share a set of common dimensions 216 (e.g., location, industry, seniority, experience level, source of job applications, payment model, availability of standardized company names, etc.).

In one or more embodiments, jobs in the same job segment are priced according to the same pricing model. For example, jobs in the same job segment may be charged the same “prepaid” price (i.e., a price that covers posting of a job throughout the job's lifetime) and/or per-action price (i.e., a CPC for a job). Moreover, the pricing model may include static pricing of jobs, so that a CPC or other per-action bid price for the job segment is fixed over the lifetime of jobs in the job segment. Alternatively, the pricing model may include dynamic pricing of jobs, in which a “base” CPC for a job is determined for a given job or job segment and dynamically adjusted based on attributes and/or behavior associated with the job.

After records in event streams 200 are aggregated by dimensions 216, stream-processing apparatus 202 uses the aggregated records to calculate delivery rates 218 of jobs in the corresponding job segments. Delivery rates 218 include proportions of time in which jobs are “overdelivered” or “underdelivered” with respect to one or more thresholds for the jobs' budgets. For example, a recent posting of a job to the online system may cause the job to be overdelivered with respect to a 30% buffer over the job's daily budget (e.g., due to high initial interest in the job). As the recency of the job decreases (e.g., as time passes since the job's posting), the job's delivery may decrease until spending on the job lies between the job's daily budget and the 30% buffer. As time continues to progress, the job's delivery may decrease further until the job is underdelivered with respect to the job's daily budget.

As a result, delivery rates 218 may include a first delivery rate representing the proportion of time and/or spending in which “overdelivery” of a job causes spending on the job to exceed the 30% buffer above the job's daily budget. The delivery rates may also include a second delivery rate representing the proportion of time and/or spending in which delivery of the job falls between the job's daily budget and the 30% buffer. The delivery rates may further include a third delivery rate representing the proportion of time and/or spending in which “underdelivery” of the job causes spending on the job to fall below the fixed budget. In subsequent discussions of delivery rates 218, r₀₁ may represent the first delivery rate, r₀₂ may represent the second delivery rate, and r_{U} may represent the third delivery rate.

To determine delivery rates 218, stream-processing apparatus 202 combines records of job-related actions from event streams 200 with prices of the actions and budgets for the jobs. For example, each job in the online system may be associated with a fixed daily budget and/or overall budget, as well as a “bid price” that represents the value of each search, click, view, application, and/or other action performed with respect to the job. Stream-processing apparatus 202 may combine the number of actions performed with respect to each job over a period over which the job's budget is to be spent (e.g., a day) with the bid price of each action for the job to determine the total “spending” associated with the job over the same period. Stream-processing apparatus 202 may then calculate delivery rates 218 by applying thresholds representing the job's budget and/or the buffer over the budget to the total spending amounts over a typical “lifetime” of the job (e.g., a 30-day period).

After delivery rates 218 are determined, stream-processing apparatus 202 stores delivery rates 218 in data repository 134 and/or another data store for subsequent retrieval and use. Stream-processing apparatus 202 may optionally transmit some or all delivery rates 218 directly to analysis apparatus 204, in lieu of or in addition to storing delivery rates 218 in the data store.

Analysis apparatus 204 applies an optimization technique 208 to delivery rates 218 associated with a job to determine a target delivery rate 214 that improves a utilization of the job's budget. In one or more embodiments, optimization technique 208 performs multi-objective optimization to select target delivery rate 214 as a value of the first, second, or third delivery rates that meets multiple optimization objectives associated with utilization of the job's budget. For example, optimization technique 208 may attempt to select target delivery rate 214 so that the job is “fully budgetized,” in which the daily budget of the job is fully spent over the period in which the job is expected to be posted (e.g., 30 days). Such full budgetization can be attained when the second delivery rate that falls between the job's daily budget and the 30% buffer over the budget is equal to the third delivery rate of the job that falls below the job's daily budget (i.e., when r₀₂=r_{U}).

As shown in FIG. 2, the optimization objectives include an overdelivery objective 210 related to overdelivery of the job beyond allowed spending for the job (e.g., views, clicks, and/or other actions performed beyond the 30% buffer over the job's daily budget). The optimization objectives also include an underdelivery objective 212 related to underdelivery of the job below allocated spending for the job (e.g., views, clicks, and/or other actions that fail to fully spend the job's daily budget).

Continuing with the above example, analysis apparatus 204 may analyze historical delivery rates 218 from stream-processing apparatus 202 and/or data repository 134 to determine the following relationship between the second and third delivery rates 218:

r_{U}=f_{U}(r₀₂)=α₁ln(r₀₂)+α₀

In the above relationship, the third delivery rate r_{U} (i.e., the “underdelivery” rate) is represented as a function of the second delivery rate r₀₂. The third delivery rate can be calculated by applying a coefficient α₁ to the natural logarithm of the second delivery rate and adding a constant α₀ to the result.

Analysis apparatus 204 may also derive, from historical delivery rates 218, the following relationship between the first and second delivery rates 218:

r₀₁=f₀₁(r₀₂)=β₀e^{β}1^{r}^{₀₂}

In the above relationship, the first delivery rate r₀₁ (i.e., the “overdelivery” rate) is represented as a function of the second delivery rate r₀₂. The first delivery rate can be calculated by applying a natural exponential function to the product of the second delivery rate and a coefficient β₁ and scaling the result of the natural exponential function by another coefficient β₀.

In turn, underdelivery objective 212 may include the following representation:

min{f_{U}(r₀₂), r₀₂∈[0, 0.3]}

Similarly, overdelivery objective 210 may include the following representation:

min{f_{U}(r₀₂), r₀₂∈[0, 0.3]}

In other words, optimization technique 208 may seek to minimize the first and third delivery rates as a function of the second delivery rate.

In one or more embodiments, optimization technique 208 includes an ε-constrained approach that prioritizes one optimization objective subject to constraints associated with other optimization objectives. For example, optimization technique 208 may set the following constraint on the first delivery rate:

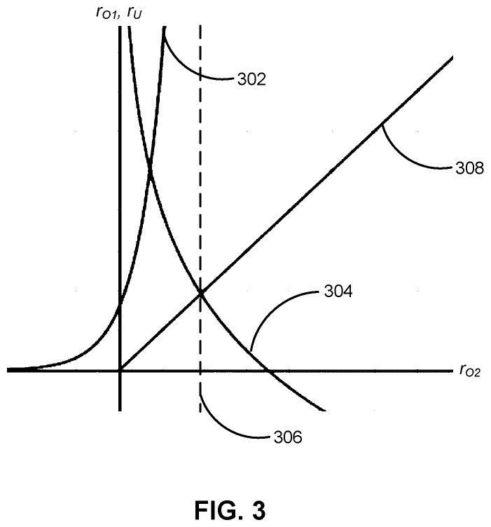

r₀₁<=ε
In the above constraint, E represents the “worst” value r₀₁ is allowed to take. Optimization technique 208 may thus seek to minimize the third delivery rate subject to the constraint by choosing target delivery rate 214 r₀₂=T that produces r₀₁=ε. Optimization techniques for selecting target delivery rates of jobs based on relationships among historical delivery rates of the jobs is described in further detail below with respect to FIG. 3.

After analysis apparatus 204 determines target delivery rate 214 for a job or job segment, analysis apparatus 204 outputs target delivery rate 214 to data repository 134 and/or management apparatus 206. Management apparatus 206 includes functionality to set pricing for the jobs, which can include an initial price 244 for the jobs and/or a change 242 to initial price 244 that improves the utilization of the fixed budget associated with the job(s). In some embodiments, initial price 244 may be selected and/or calculated using a static rate card, and change 242 may be calculated based on historical delivery rates 218 associated with initial price 244 and target delivery rate 214 outputted by optimization technique 208.

For example, management apparatus 206 may calculate initial price 244 as the CPC of a job. The CPC may be obtained by dividing the “prepaid” price for the job's segment from the static rate card by a median number of views, clicks, and/or other actions related to jobs in the segment over a period (e.g., 30 days) and scaling the result by a factor. One or more boundaries 246 (e.g., lower and upper bounds based on the location associated with the job segment) may optionally be applied to the CPC to ensure that the CPC is neither too high nor too low. Moreover, the CPC may be calculated for jobs that are both prepaid and PPC, so that the CPC can be used as a measure of the jobs' “values” during subsequent ranking and/or delivery of the jobs within the online system.

Next, management apparatus 206 calculates change 242 to initial price 244 based on target delivery rates 214 from analysis apparatus 204. For example, management apparatus 206 may use the following formulas to calculate change 242:

$${r}_{O 2} = {f}_{O 2} ( {γ}_{cpc} ) = {θ}_{1} ln ( {γ}_{cpc} ) + {θ}_{0}$$

$${γ}_{cpc} = {e}^{( \frac{Δ}{{θ}_{1}} )} , Δ = T - {r}_{O 2 Current}$$

In the above formulas, the second delivery rate r₀₂ is calculated as a function of γ_{cpc}, which represents change 242 in initial price 244. The second delivery rate is obtained by applying a coefficient θ₁ to the natural logarithm of change 242 and adding a constant θ₀ to the result. Values of θ₁ and θ₀ may be obtained by analyzing historical delivery rates 218 and CPCs for jobs in the same job segment. In turn, change 242 may be calculated by applying the natural exponential function to a ratio of Δ to θ₁, where Δ represents the difference between target delivery rate 214 T and the current value of the second delivery rate r_{02 Current} for a given job segment.

Management apparatus 206 applies change 242 to initial price 244 to obtain an updated price 248 for jobs in the job segment, subject to boundaries 246 associated with change 242 and/or the updated price. For example, change 242 may include a scaling factor by which initial price 244 is multiplied to obtain updated price 248. Boundaries 246 may include upper and lower limits on the values of changes 242, as well as upper and lower limits on the resulting value of updated price 248. Boundaries 246 may be set to ensure that updated price 248 does not result in excessive underdelivery and/or overdelivery of the corresponding jobs.

Finally, management apparatus 206 uses updated price 248 to deliver the job within the online system. For example, management apparatus 206 may generate an overall score for each job as a weighted combination of a user's predicted likelihood of clicking, applying to, and/or otherwise interacting with the job; updated price 248; a “pacing score” that is used to pace delivery of the job so that the job's budget is spent over the period spanned by the budget (e.g., a day); and/or other factors. Management apparatus 206 may then rank a set of jobs by descending score and display the ranking to the user. Since the user is more likely to take action on higher-ranked jobs than on lower-ranked jobs, ranking of the jobs based on updated price 248 may allow subsequent actions on the jobs to be increased or decreased accordingly.

By using multi-objective optimization to adjust bid prices of jobs, the system of FIG. 2 may improve utilization of the jobs' budgets and/or management of other constraints or priorities associated with the jobs. In contrast, conventional techniques may generate bid prices for the jobs based on static rate cards, which can result in overdelivery of the jobs beyond the jobs' budgets and/or underdelivery of the jobs below the jobs' budgets. Consequently, the disclosed embodiments may provide improvements in computer systems, applications, user experiences, tools, and/or technologies related to delivering online content and/or carrying out activities within online systems.

Those skilled in the art will appreciate that the system of FIG. 2 may be implemented in a variety of ways. First, stream-processing apparatus 202, analysis apparatus 204, management apparatus 206, and data repository 134 may be provided by a single physical machine, multiple computer systems, one or more virtual machines, a grid, one or more databases, one or more filesystems, and/or a cloud computing system. Stream-processing apparatus 202, analysis apparatus 204, and management apparatus 206 may additionally be implemented together and/or separately by one or more hardware and/or software components and/or layers.

Second, a number of techniques may be used to determine target delivery rate 214, change 242, updated price 248, and/or other values related to bid optimization for jobs. For example, the functionality of analysis apparatus 204 and/or management apparatus 206 may be provided by various multi-objective optimization techniques, machine learning models, and/or other computational or technological solutions.

Third, the functionality of the system may be adapted to various types of activities and/or pricing. For example, the system may be used to adjust the pricing and/or delivery of advertisements, posts, images, audio, video, and/or other types of online content to reflect limitations, constraints, priorities, and/or requirements associated with the availability, budgets, and/or “value” of the content.

FIG. 3 shows an example plot in accordance with the disclosed embodiments. More specifically, FIG. 3 shows a plot of two curves 302-304 representing relationships between delivery rates of jobs in an online system. Curve 302 shows a first delivery rate representing overdelivery of the jobs beyond a buffer associated with the jobs' fixed (e.g., daily) budgets (i.e., r₀₁) as a function of a second delivery rate representing delivery of the jobs between the jobs' fixed budgets and the buffer (i.e., r₀₂). Curve 304 shows a third delivery rate representing underdelivery of the jobs below the jobs' fixed budgets (i.e., r_{U}) as a function of the second delivery rate.

The plot of FIG. 3 shows two additional lines 306-308 representing parameters and/or constraints associated with an optimization technique (e.g., optimization technique 208 of FIG. 2) for selecting a target value of the second delivery rate. Line 306 represents a constraint on the value of the first delivery rate (i.e., r₀₁<=ε), and line 308 represents equality of the second and third delivery rates, which allows for full budgetization of the job.

Curves 302-304 and lines 306-308 may be used to select a target value for the second delivery rate that fully budgetizes the job without exceeding the constraint associated with the first delivery rate. For example, the intersection of curve 304 and line 308 may be used to identify the target value of the second delivery rate (subject to the constraint represented by line 306), and curves 302-304 may be used to determine corresponding values of the first and third delivery rates based on the target value. A difference between the current value of the second delivery rate and the target value may then be used to calculate an updated price for the job that improves utilization of the job's budget over time, as discussed above.

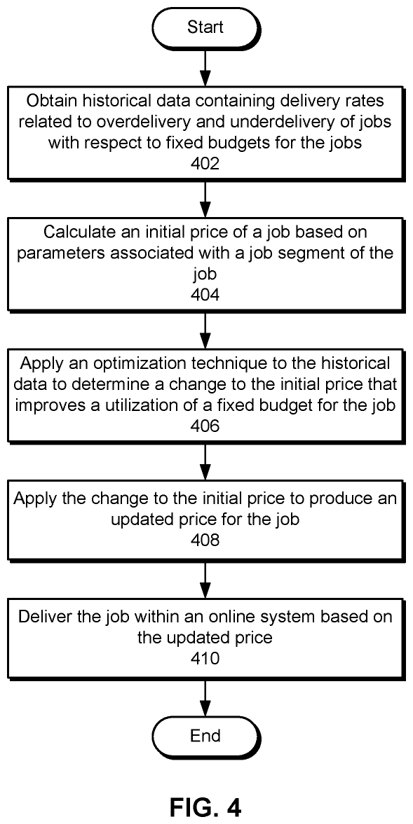

FIG. 4 shows a flowchart illustrating a process of performing delivery-based bid optimizations for jobs in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, historical data containing delivery rates related to overdelivery and underdelivery of jobs with respect to fixed budgets for the jobs is obtained (operation 402). For example, the delivery rates may include a first delivery rate that represents overdelivery of the jobs beyond a buffer associated with the fixed budgets, a second delivery rate between the fixed budgets and the buffers, and/or a third delivery rate that represents underdelivery of the jobs below the fixed budgets.

Next, an initial price of a job is calculated based on parameters associated with a job segment of the job (operation 404). For example, the job segment may include dimensions such as a region, an experience level associated with the job, a standardized title for the job, a source of an application for the job, a payment model for the job, and/or an availability of a standardized company name associated with the job. Parameters used to calculate the initial price may include a prepaid price, a historical view rate, and/or historical delivery rates associated with the job segment.

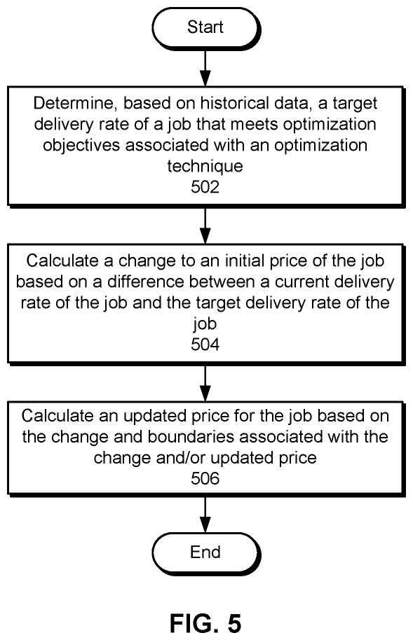

An optimization technique is applied to the historical data to determine a change to the initial price that improves a utilization of a fixed budget for the job (operation 406), and the change is applied to the initial price to produce an updated price for the job (operation 408), as described in further detail below with respect to FIG. 5. The job is then delivered within an online system based on the updated price (operation 410). For example, the updated price may be combined with other factors to produce a score for the job, and the job may be displayed and/or ranked within emails to job seekers, a job search and/or job recommendation module in the online system, and/or other communications with the job seekers based on the score.

FIG. 5 shows a flowchart illustrating a process of calculating an updated price for a job in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a target delivery rate of a job that meets optimization objectives associated with an optimization technique is determined (operation 502). For example, the optimization technique may include an ε-constrained optimization technique and/or another type of multi-objective optimization technique. Optimization objectives associated with the optimization technique may include, but are not limited to, minimizing underdelivery and/or overdelivery of the job. The optimization technique may select the target delivery rate that minimizes underdelivery of the job while enforcing a constraint associated with overdelivery of the job.

Next, a change to an initial price of the job is calculated based on a difference between a current delivery rate of the job and the target delivery rate of the job (operation 504). For example, the change may be calculated based on a ratio of the difference between the current delivery rate and the target delivery rate to a factor representing a historical relationship between the change to the initial price and the current delivery rate.

An updated price for the job is then calculated based on the change and boundaries associated with the change and/or updated price (operation 506). For example, the updated price may be calculated by applying the change to the initial price, subject to upper and/or lower bounds that limit the minimum and/or maximum values of the change and/or updated price. The updated price may then be used to control and/or adjust delivery of the job in an online system, as discussed above.

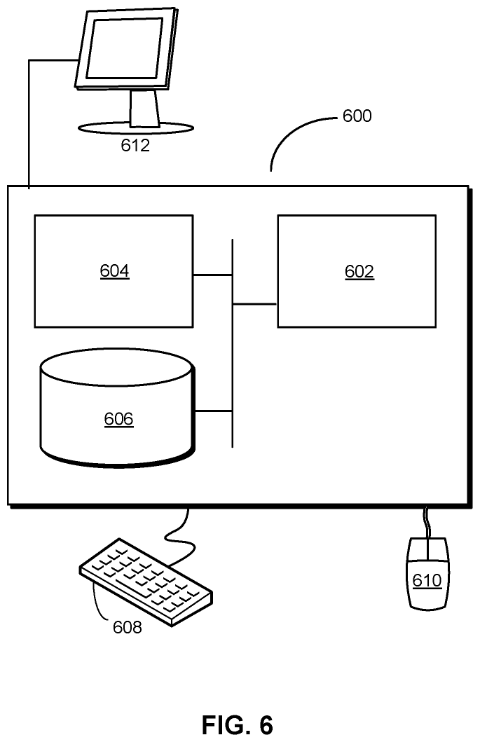

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for performing delivery-based bid optimizations for jobs and/or other types of opportunities. The system includes a stream-processing apparatus, an analysis apparatus, and a management apparatus, one or more of which may alternatively be termed or implemented as a module, mechanism, or other type of system component. The stream-processing apparatus obtains historical data containing delivery rates related to overdelivery and underdelivery of jobs and/or opportunities with respect to fixed budgets for the jobs and/or opportunities. Next, the analysis apparatus applies an optimization technique to the historical data to determine a change to an initial price for a job/opportunity that improves a utilization of a fixed budget for the job/opportunity. The management apparatus then applies the change to the initial price to produce an updated price for the job/opportunity and delivers the job/opportunity within an online system based on the updated price.

In addition, one or more components of computer system 600 may be remotely located and connected to the other components over a network. Portions of the present embodiments (e.g., stream-processing apparatus, analysis apparatus, management apparatus, data repository, online network, etc.) may also be located on different nodes of a distributed system that implements the embodiments. For example, the present embodiments may be implemented using a cloud computing system that controls the delivery of jobs, opportunities, advertisements, and/or other content to a set of remote users based on constraints associated with the content's pricing, delivery, and/or budgets.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining historical data comprising delivery rates related to overdelivery and underdelivery of jobs with respect to fixed budgets for the jobs;
applying, by one or more computer systems, an optimization technique to the historical data to determine a change to an initial price for a job that improves a utilization of a fixed budget for the job;
applying, by the one or more computer systems, the change to the initial price to produce an updated price for the job; and
delivering the job within an online system based on the updated price.

2. The method of claim 1, further comprising:
calculating the initial price of the job based on parameters associated with a job segment of the job.

3. The method of claim 2, wherein the job segment comprises at least one of:
a region;
an experience level associated with the job;
a standardized title for the job;
a source of an application for the job;
a payment model for the job;
an availability of a standardized company name associated with the job.

4. The method of claim 2, wherein the parameters comprise at least one of:
a prepaid price associated with the job segment; and
a historical view rate associated with the job segment.

5. The method of claim 1, wherein applying the optimization technique to the historical data and the current price of the job to determine the change to the initial price that improves the utilization of the fixed budget for the job comprises:
determining, based on the historical data, a target delivery rate of the job that meets one or more optimization objectives associated with the optimization technique; and
calculating the change to the initial price based on a difference between a current delivery rate of the job and the target delivery rate of the job.

6. The method of claim 5, wherein the one or more optimization objectives comprise minimizing an underdelivery of the job.

7. The method of claim 6, wherein the one or more optimization objectives further comprise a constraint on overdelivery of the job.

8. The method of claim 5, wherein calculating the change to the initial price based on the difference between the current delivery rate of the job and the target delivery rate of the job comprises:
calculating the change to the initial price based on a ratio of the difference between the current delivery rate and the target delivery rate to a factor representing a historical relationship between the change to the initial price and the current delivery rate.

9. The method of claim 1, wherein applying the change to the initial price to produce the updated price for the job comprises:
limiting the updated price to fall within one or more boundaries.

10. The method of claim 9, wherein the one or more boundaries comprise:
a first limit on the current price; and
a second limit on the change in the current price.

11. The method of claim 9, wherein the one or more boundaries comprise:
an upper bound; and
a lower bound.

12. The method of claim 1, wherein the delivery rates comprise:
a first delivery rate that represents overdelivery of the jobs beyond a buffer associated with the fixed budgets;
a second delivery rate between the fixed budgets and the buffers; and
a third delivery rate that represents underdelivery of the jobs below the fixed budgets.

13. A system, comprising:
one or more processors; and
memory storing instructions that, when executed by the one or more processors, cause the system to:
obtain historical data comprising delivery rates related to overdelivery and underdelivery of jobs in a job segment with respect to fixed budgets for the jobs;
apply an optimization technique to the historical data to determine a change to an initial price for a job that improves a utilization of a fixed budget for the job;
apply the change to the initial price to produce an updated price for the job; and
deliver the job within an online system based on the updated price.

14. The system of claim 13, wherein the memory further stores instructions that, when executed by the one or more processors, cause the system to:
calculate the initial price of the job based on parameters associated with the job segment.

15. The system of claim 14, wherein the parameters comprise at least one of:
a prepaid price associated with the job segment; and
a historical view rate associated with the job segment.

16. The system of claim 13, wherein applying the optimization technique to the historical data and the current price of the job to determine the change to the initial price that improves the utilization of the fixed budget for the job comprises:
determining, based on the historical data, a target delivery rate of the job that meets one or more optimization objectives associated with the optimization technique; and
calculating the change to the initial price based on a difference between a current delivery rate of the job and the target delivery rate of the job.

17. The system of claim 16, wherein the one or more optimization objectives comprise:
minimizing an underdelivery of the job; and
a constraint on overdelivery of the job.

18. The system of claim 13, wherein the delivery rates comprise:
a first delivery rate that represents overdelivery of the jobs beyond a buffer associated with the fixed budgets;
a second delivery rate between the fixed budgets and the buffers; and
a third delivery rate that represents underdelivery of the jobs below the fixed budgets.

19. The system of claim 13, wherein the job segment comprises at least one of:
a region;
an experience level associated with the job;
a standardized title for the job;
a source of an application for the job;
a payment model for the job;
an availability of a standardized company name associated with the job.

20. A non-transitory computer-readable storage medium storing instructions that when executed by a computer cause the computer to perform a method, the method comprising:
obtaining historical data comprising delivery rates related to overdelivery and underdelivery of opportunities with respect to fixed budgets for the opportunities;
applying an optimization technique to the historical data to determine a change to an initial price for an opportunity that improves a utilization of a fixed budget for the opportunity;
applying the change to the initial price to produce an updated price for the opportunity; and
delivering the opportunity within an online system based on the updated price.
